(19) United States
(12) Patent Application Publication
(10) Pub. No.: US 2019/0118672 A1
(43) Pub. Date: Apr. 25, 2019

(54) A POWER RAIL EXPANSION JOINT WITHOUT EXPANSION GAP

(71) Applicant: Hunan Huapin Rail Transit Co., Ltd, Hunan (CN)

(72) Inventors: Jian ZENG, Hunan (CN); Xingzhen JIANG, Hunan (CN); Guihang LI, Hunan (CN); Maotao DENG, Hunan (CN)

(21) Appl. No.: 16/090,020

(22) PCT Filed: Mar. 27, 2017
(86) PCT No.: PCT/CN2017/078245

§ 371 Date: Sep. 28, 2018

(30) Foreign Application Priority Data
Mar. 28, 2016 (CN) 201610175914.0

(51) Int. Cl. B60M 1/30; E01B 11/00

(52) U.S. Cl. CPC B60M 1/305; E01B 11/00

(57) ABSTRACT

In the disclosure, a power rail expansion joint without expansion gap is provided, which comprises two power rail sections, a limiting guide block, a sliding contact plate and an electric conductor. The two power rail sections cooperate with the limiting guide block, with a sliding clearance therebetween. At least one sliding contact plate is mounted on the limiting guide block or base bodies of the power rail sections, and has a contact surface of the sliding contact plate arranged in a same working surface with outer contact surfaces of the power rail sections. The sliding contact plate is configured to partially or completely cover an expansion separation between the two power rail sections. The sliding contact plate comprises at least one edge which is in an angle of less than 90° with respect to an expansion or contraction direction of the power rail sections. When the two power rail sections are displaced in the lengthwise direction to cause variation of the expansion separation, the sliding contact plate will correspondingly take place displacement in the contact working surface in a direction perpendicular to the expansion or contraction direction of the power rail sections, so as to accommodate the variation of the expansion separation. There is at least one electric conductor connected to the limiting guide plate or/and the two power rail sections to establish electric connection.

### TECHNICAL FIELD

The disclosure relates to an expansion joint used in a power rail system for a rail transit.

### BACKGROUND

The expansion joint of preamble type is mainly applied to realizing compensation for thermal expansion or contraction and mechanical displacement of power rail as well as electric conduction for power rail. According to description of expansion joint in CN patent issuance No. CN102427172B, said expansion joint has solved the problems of thermal expansion or contraction, mechanical displacement, electric conduction, adjoining resistance and expansion resistance in the power rail system. However, such expansion joint which is applied practically is not totally satisfying and it has the following deficiencies.

The prior art expansion joint reserves expansion gap for compensation for thermal expansion or contraction and mechanical displacement of a power rail. When the temperature of power rail increases, two power rail sections expand towards expansion gaps with gap length shortening, and vice versa. The expansion gap cannot be eliminated from such expansion joint. It is found in practice that when the current collector passes through said expansion joint with expansion gap, the current collector shoe thereof is affected by the expansion gap with contact posture of the collector shoe shifted from plane-plane contact to complicated contact and then back to plane-plane contact. Collector shoe is affected more severely with greater expansion gap and higher passing speed. It is the reason that current collector produces impact noise and works unstably occasionally during passing through said joint. The said noise can be very significant under the low-noise circumstance of maglev transit. The impact may lead to visible or potential damage to current collector and its connection mechanism, and go against current collecting as well.

### SUMMARY

The objective of the disclosure is to solve said problems by providing an expansion joint without expansion gap used in a power rail system for a rail transit. The expansion joint is able to compensate for thermal expansion or contraction and mechanical displacement of the power rail, eliminate adjoining resistance and expansion resistance, and realize electric conduction for the power rail system. Furthermore, the expansion joint eliminates expansion gap by a sliding contact plate (D) for partially or completely covering the expansion separation (δ) between two power rail sections (A, B) to eliminate impact noise and current collecting instability and to protect current collector and its connection mechanism.

In the disclosure, a power rail expansion joint without expansion gap is provided, which at least comprises two power rail sections (A, B), a limiting guide block (C), a sliding contact plate (D), and a conductor (F); wherein the two power rail sections (A,B) cooperate respectively with the limiting guide block (C) with a sliding clearance therebetween, such that the power rail sections (A, B) are configured to just expand or contract in a lengthwise direction thereof. The limiting guide block (C) is connected to the power rail sections (A, B) by means of insertion or/and clamping. The expansion joint comprises at least one conductor (F) which is connected to the limiting guide block (C) or/and the two power rail sections (A, B) to realize electrical conduction. At least one sliding contact plate (D) is mounted on the limiting guide block (C) or base bodies of the power rail sections (A, B), and has a contact surface (Dm) of the sliding contact plate (D) arranged in a same working surface with outer contact surfaces (Am, Bm) of the power rail sections (A, B). The sliding contact plate (D) is configured to partially or completely cover an expansion separation (δ) between the two power rail sections (A, B). The sliding contact plate (D) comprises at least one edge (D1) which is in an angle of less than 90° with respect to an expansion or contraction direction of the power rail sections (A, B). When the two power rail sections (A, B) are displaced in the lengthwise direction to cause variation of the expansion separation (δ), the sliding contact plate (D) will correspondingly take place displacement in the contact working surface in a direction perpendicular to the expansion or contraction direction of the power rail sections, so as to accommodate the variation of the expansion separation (δ).

Preferably, the sliding contact plate (D) is mounted on a mount base (D2) which may be configured as the limiting guide block (C) or the base bodies of the power rail sections (A, B), said sliding contact plate (D) cooperating with said mount base (D2) through a sliding groove mechanism (d) as a transmission (h). When said two power rail sections (A, B) are displaced due to expansion or contraction, the sliding contact plate (D) will take place sliding displacement correspondingly through the sliding groove mechanism (d) in a direction perpendicular to the expansion or contraction direction of the power rail sections (A, B).

Preferably, the sliding groove mechanism (d) is configured as a dovetail groove.

Preferably, a spring (g) is arranged between the sliding contact plate (D) and the mount base (D2), such that a thrust or tension force of the spring (g) causes the edge (D1) of the sliding contact plate (D) to contact with, and thus slide on, an edge of the power rail or an edge (E1) of other sliding contact plate.

Preferably, when the two power rail sections (A, B) take place contraction or expansion in the lengthwise direction, the power rail sections (A, B) are connected to the sliding contact plate (D) through said transmission (h) such that the sliding contact plate (D) is moved along the sliding groove (d). The sliding contact plate (D) is connected to said transmission (h). Transmission ratio of said transmission (h) corresponds to the edge slope of the sliding contact plate (D), such that the edge(s) (D1, E1) of the sliding contact plate(s) (D, E) is/are moved relatively to the adjacent edge(s) of the power rail sections (A, B) with fit clearance therebetween remaining unchanged.

Preferably, said transmission (h) comprises a rack (h1) and a gear (h2) which are connected to the power rail sections (A, B), and a rack (h3) which is connected to the sliding contact plate (D).

Preferably, said transmission (h) may also comprise a guide pulley/track (h4) arranged on the power rail sections (A, B) and a guide block/groove (h5) arranged on the sliding contact plate (D). Alternatively, the guide block/groove (h5) may be arranged on the power rail sections (A, B) and the guide pulley/track (h4) may be arranged on the sliding contact plate (D).

Preferably, the at least one sliding contact plate comprises two sliding contact plates (D, E) configured geometrically similar to each other.

Preferably, the limiting guide block (C) is configured as a conductive member as well. The sliding contact plate (D) and the transmission (h) are mounted on said limiting guide block (C), and both ends of the limiting guide block (C) are electrically connected to said two power rail sections (A, B) though the conductor (F).

Preferably, the limiting guide block (C) is fixed on a groundwork by a separate insulation support (Z).

The disclosure has the advantages as follows:

In related arts, the expansion gap is reversed for compensation for thermal expansion or contraction and mechanical displacement of the power rail. On the contrary, the disclosure ensures that the sliding contact plate is configured to partially or completely cover the expansion gap between the two power rail sections, such that the current collector remains plane-to-plane contact during passing through expansion joint, so as to eliminate impact noise and current collecting instability, also improve service life of the current collector and its connection mechanism, and facilitate to increase operating speed. The disclosure ensures that when the sliding contact plate is moved, the current collector shoe is in complete contact with the current collecting surfaces of the power rails, which in turn ensures the so-called “broad-rail and narrow-shoe” arrangement.

### BRIEF DESCRIPTION OF DRAWINGS

The disclosure will now be detailed in reference to the accompanying drawings, in which:

FIG. 1 shows views (I)-(V) of different combinations of power rail sections and a sliding contact plate in terms of their current-collecting working surfaces.

FIG. 2 shows a view of an expansion joint without expansion gap used in a C-shaped power rail with sliding track and groove mechanism as a transmission (in which a limiting guide is arranged in the middle).

FIG. 3 shows a view of an expansion joint without expansion gap used in a C-shaped power rail with sliding track and groove mechanism as a transmission (in which limiting guides are arranged at two ends).

FIG. 4 shows a view of an expansion joint without expansion gap used in a C-shaped power rail with gear and rack mechanism as a transmission.

FIG. 5 shows a view of an expansion joint without expansion gap used in a C-shaped power rail with spring mechanism as a transmission.

FIG. 6 shows a view of an expansion joint without expansion gap used in an I-shaped power rail with sliding track and groove mechanism as a transmission (in which a limiting guide is arranged in the middle).

FIG. 7 shows a view of an expansion joint without expansion gap used in an I-shaped power rail with sliding groove mechanism as a transmission (in which limiting guides are arranged at two ends).

### DETAILED DESCRIPTION OF EMBODIMENTS

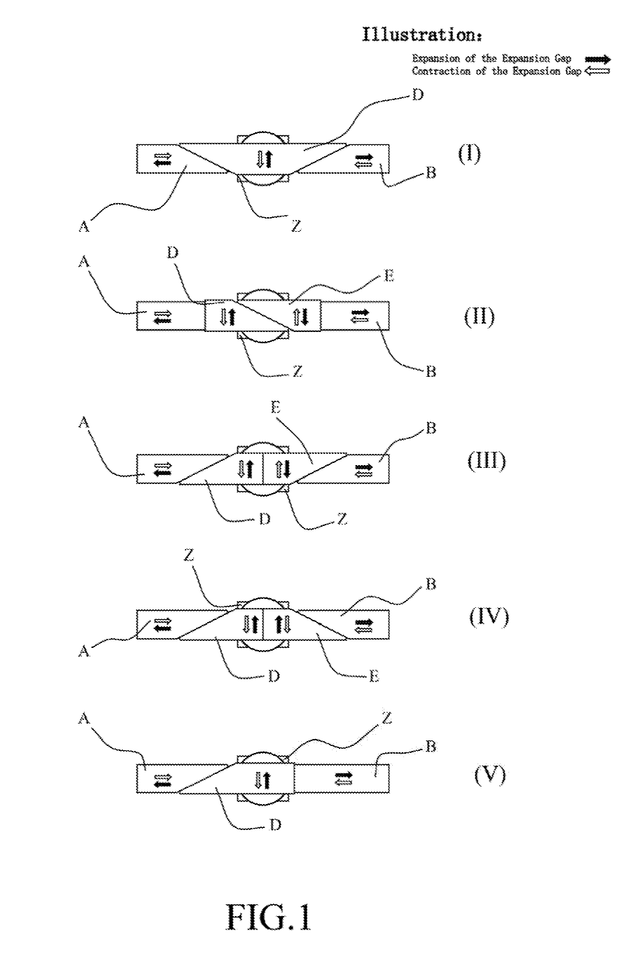

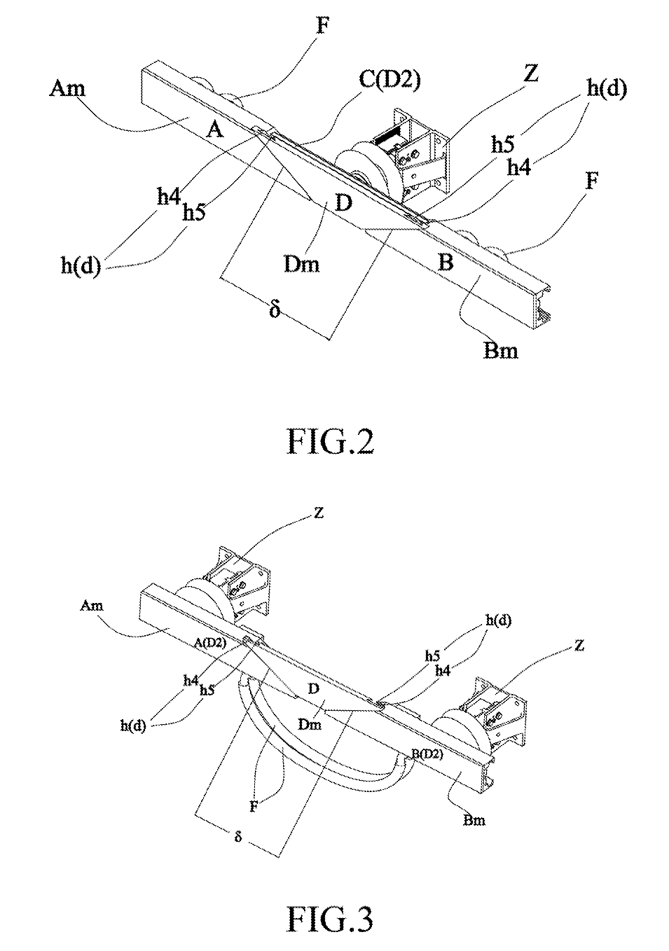

First exemplary embodiment: as shown in FIG. 1(I) and FIG. 2, an expansion joint without expansion gap used in C-shaped power rail is illustrated with sliding track and groove mechanism as a transmission. A limiting guide block (C) is inserted into C-shaped grooves of two C-shaped power rail sections (A, B), respectively, with a sliding clearance between the power rail sections and the limiting guide block. The C-shaped power rail sections (A, B) are configured to just slide in their lengthwise directions. A sliding contact plate (D) is configured to partially or completely cover an expansion separation (δ) between the two power rail sections (A, B); and the outer contact surface (Dm) of the sliding contact plate (D) is in the same plane with the contact surfaces (Am, Bm) of the power rail sections (A, B) in the three-dimensional space, such that a current collector may pass through them without impact caused. The transmission (h) comprises a guide track (h4) arranged on the sliding contact plate (D) and a dovetail groove (h5) arranged on the limiting guide block (C). When said two power rail sections (A, B) are displaced in the lengthwise direction due to thermal factor, the sliding contact plate (D) will correspondingly take place sliding displacement in a direction perpendicular to the lengthwise direction of the power rail sections (A, B) by means of the transmission (h), with a displacement component in the lengthwise direction of the power rail sections (A, B), such that variation of the expansion separation (δ) will be accommodated. In such case, the sliding contact plate (D) will be maintained to adjacently contact with ends of the power rail sections (A, B) during the said displacement. Two conductors (F) of soft copper strip are electrically connected to two ends of the limiting guide block (C), respectively and the other ends of the conductors (F) are connected to the power rail sections (A or B), respectively, such that electric conduction of the power rail is established. The limiting guide block (C) is fixed on a groundwork by an insulation support (Z) for supporting the power rail sections (A, B) and limiting their positions, such that for the power rail system, not only positions of expansion and contraction are limited, but also electric connection is realized in expansion and contraction, free of adjoining resistance, deformation and expansion gap.

Second exemplary embodiment: as shown in FIG. 1(I) and FIG. 3, an expansion joint without expansion gap used in a C-shaped power rail is illustrated with sliding track and groove mechanism as a transmission. Two limiting guide blocks (C) fixed by two insulation supports (described in CN103991391A) respectively (attachment chucks on insulators) are inserted into C-shaped grooves of C-shaped power rail sections (A, B), respectively. The power rail sections (A, B) are configured to slide in their lengthwise direction. A sliding contact plate (D) is mounted on the expansion joint, and is configured to partially or completely cover the expansion gap (δ) between the two power rail sections (A, B); and the outer contact surface (Dm) of the sliding contact plate (D) is in the same plane with the contact surfaces (Am, Bm) of the power rail sections (A, B) in the three-dimensional space, such that a current collector may pass through them without impact caused. The transmission (h) comprises a guide track (h4) arranged on the sliding contact plate (D) and a dovetail groove (h5) arranged on the limiting guide blocks (C). When said two power rail sections (A, B) are displaced in the lengthwise direction due to thermal factor, the sliding contact plate (D) will correspondingly take place sliding displacement in a direction perpendicular to the lengthwise direction of the power rail sections (A, B) by means of the transmission (h), with a displacement component in the lengthwise direction of the power rail sections (A, B), such that variation of the expansion separation (δ) will be accommodated. In such case, the sliding contact plate (D) will be maintained to adjacently contact with ends of the power rail sections (A, B) during the said displacement. A bridging cable conductor (F) at one end thereof is electrically and securely connected to an end of the power rail section (A), and at the other end is securely connected to the power rail section (B), such that electric conduction of the power rail is established. The two limiting guide blocks (C) are fixed on a groundwork by two insulation supports (Z), such that for the power rail system, not only positions of expansion and contraction are limited, but also electric connection is realized in expansion and contraction, free of adjoining resistance, deformation and expansion gap.

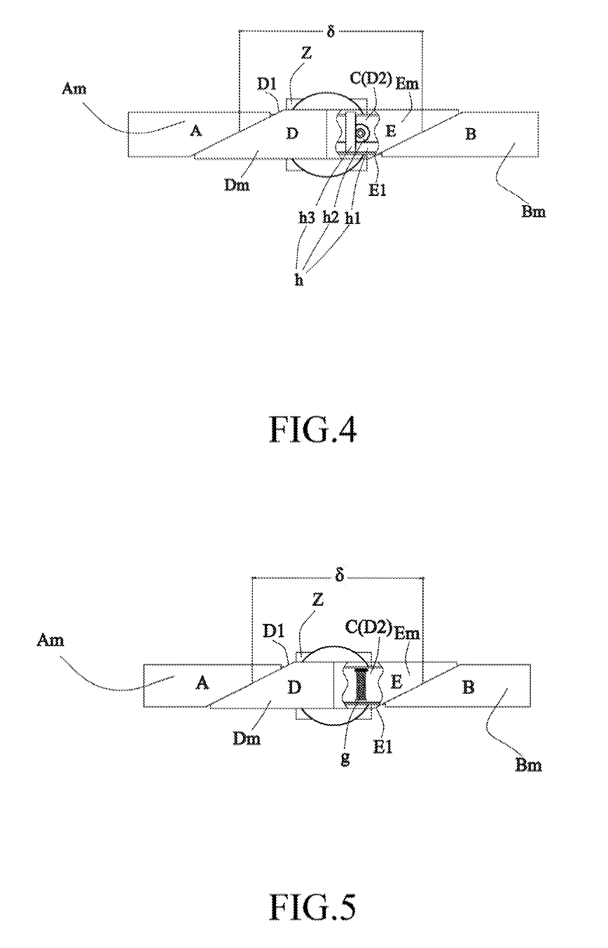

Third exemplary embodiment: as shown in FIG. 1(III) and FIG. 4, an expansion joint without expansion gap used in a C-shaped power rail is shown with gear and rack mechanism as a transmission. Two ends of limiting guide block (C) are respectively inserted into grooves of the C-shaped power rail sections (A, B), with a sliding clearance between the power rail sections and the limiting guide block. The C-shaped power rail sections (A, B) are configured to just slide in their lengthwise direction; Two sliding contact plates (D, E) are mounted on the limiting guide block (C), and are configured to cover the expansion separation (δ) between the two power rail sections (A, B). The sliding contact plates (D, E) will be maintained to adjacently contact with the power rail sections (A, B); and the outer contact surfaces (Dm, Em) of the sliding contact plates (D, E) are in the same plane with the contact surfaces (Am, Bm) of the power rail sections (A,B) in the three-dimensional space, such that a current collector may pass through them without impact caused. The sliding contact plates (D) are connected to the limiting guide block (C) by means of groove mechanism (d). When said two power rail sections (A, B) are displaced in the lengthwise direction due to thermal factor, the sliding contact plate (D) will correspondingly take place sliding displacement in a direction perpendicular to the lengthwise direction of the power rail sections (A, B) by means of the transmission (h) which comprises a gear rack (h1) and a gear (h2) connected to the power rail sections (A, B), and a gear rack (h3) connected to the sliding contact plates (D). Two conductors (F) of soft copper strip (see FIG. 2) are electrically connected to two ends of the limiting guide block (C), respectively and the other ends of the conductors (F) are connected to the power rail sections (A or B), respectively, such that electric conduction of the power rail is established. The limiting guide block (C) is fixed on a groundwork by an insulation support (Z) for supporting the power rail sections (A, B) and limiting their positions, such that for the power rail system, not only positions of expansion and contraction are limited, but also electric connection is realized in expansion and contraction, free of adjoining resistance, deformation and expansion gap.

Fourth exemplary embodiment: as shown in FIG. 1(III) and FIG. 5, an expansion joint without expansion gap used in a C-shaped power rail is illustrated with spring mechanism as a transmission. Two limiting guide blocks (C) are inserted into C-shaped grooves of C-shaped power rail sections (A, B), respectively, with a sliding clearance between the power rail sections and the limiting guide blocks, such that the C-shaped power rail sections (A, B) are configured to just slide in their lengthwise direction. Two sliding contact plates (D, E) are mounted on the limiting guide block (C), and are configured to partially and completely cover the expansion separation (δ) between the two power rail sections (A, B). The sliding contact plates (D, E) will be maintained to adjacently contact with the power rail sections (A, B); and the outer contact surfaces (Dm, Em) of the sliding contact plates (D, E) are in the same plane with the contact surfaces (Am, Bm) of the power rail sections (A,B) in the three-dimensional space, such that a current collector may pass through them without impact caused. A spring (g) is arranged between the sliding contact plate (D) and a mount base (D2), such that when said two power rail sections (A, B) are displaced in the lengthwise direction due to thermal factor, a thrust or tension force of the spring (g) causes the edge (D1) of the sliding contact plate (D) to contact with, and thus slide on, the edge of the power rail or the edge (E1) of the other sliding contact plate. Two conductors (F) of soft copper strip (see FIG. 2) are electrically connected to two ends of the limiting guide block (C), respectively and the other ends of the conductors (F) are connected to the power rail sections (A or B), respectively, such that electric conduction of the power rail is established. The limiting guide block (C) is fixed on a groundwork by an insulation support (Z) for supporting the power rail sections (A, B) and limiting their positions, such that for the power rail system, not only positions of expansion and contraction are limited, but also electric connection is realized in expansion and contraction, free of adjoining resistance, deformation and expansion gap.

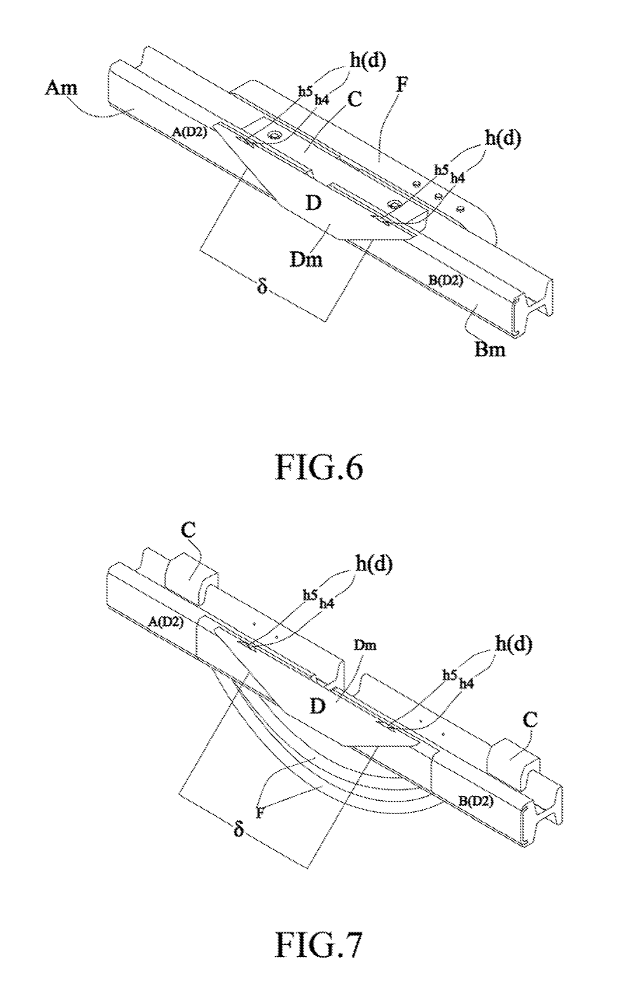

Fifth exemplary embodiment: as shown in FIG. 1(I) and FIG. 6, an expansion joint without expansion gap used in an I-shaped power rail, in which a limiting guide is arranged in the middle, is illustrated with sliding track and groove mechanism as a transmission. A pair of limiting guide blocks (C) clamp two I-shaped power rail sections (A, B), respectively, with a sliding clearance between the power rail sections and the limiting guide blocks. The two power rail sections (A, B) are configured to slide in their lengthwise direction. A sliding contact plate (D) is configured to partially or completely cover an expansion separation (δ) between the two power rail sections (A, B); and the outer contact surface (Dm) of the sliding contact plate (D) is in the same plane with the contact surfaces (Am, Bm) of the power rail sections (A, B) in the three-dimensional space, such that a current collector may pass through them without impact caused. The transmission (h) comprises a guide track (h4) arranged on the sliding contact plate (D) and a dovetail groove (h5) arranged on the limiting guide block (C). When said two power rail sections (A, B) are displaced in the lengthwise direction due to thermal factor, the sliding contact plate (D) will correspondingly take place sliding displacement in a direction perpendicular to the lengthwise direction of the power rail sections (A, B) by means of the transmission (h), with a displacement component in the lengthwise direction of the power rail sections (A, B), such that variation of the expansion separation (δ) will be accommodated. In such case, the sliding contact plate (D) will be maintained to adjacently contact with ends of the power rail sections (A, B) during the said displacement. A conductor (F) of loop soft copper strip is electrically connected to the power rail sections (A or B), respectively, such that electric conduction of the power rail is established. For the power rail system, therefore not only positions of expansion and contraction are limited, but also electric connection is realized in expansion and contraction, free of expansion gap.

Sixth exemplary embodiment: as shown in FIG. 1(I) and FIG. 7, an expansion joint without expansion gap used in an I-shaped power rail, in which limiting guides are arranged at two ends, is illustrated with sliding track and groove mechanism as a transmission. Two limiting guide blocks (C) lock lower portions of I-shaped power rail sections (A, B), respectively. The power rail sections (A, B) are configured to slide in their lengthwise direction. A sliding contact plate (D) is mounted on the expansion joint, and is configured to partially or completely cover the expansion gap (δ) between the two power rail sections (A, B); and the outer contact surface (Dm) of the sliding contact plate (D) is in the same plane with the contact surfaces (Am, Bm) of the power rail sections (A,B) in the three-dimensional space, such that a current collector may pass through them without impact caused. The transmission (h) comprises a guide track (h4) arranged on the sliding contact plate (D) and a dovetail groove (h5) arranged on the limiting guide blocks (C). When said two power rail sections (A, B) are displaced in the lengthwise direction due to thermal factor, the sliding contact plate (D) will correspondingly take place sliding displacement in a direction perpendicular to the lengthwise direction of the power rail sections (A, B) by means of the transmission (h), with a displacement component in the lengthwise direction of the power rail sections (A, B), such that variation of the expansion separation (δ) will be accommodated. In such case, the sliding contact plate (D) will be maintained to adjacently contact with ends of the power rail sections (A, B) during the said displacement. A bridging cable conductor (F) at one end thereof is electrically and securely connected to an end of the power rail section (A), and at the other end is securely connected to the power rail section (B), such that electric conduction of the power rail is established. The two limiting guide blocks (C) are fixed on a groundwork by two insulation supports (Z), such that for the power rail system, not only positions of expansion and contraction are limited, but also electric connection is realized in expansion and contraction, free of adjoining resistance and expansion gap.

The disclosure should be understood to include, to the extent of non-contradiction, all combinations of features or steps of methods or processes described herein.

Unless indicated otherwise, any single feature recited in the specification, including any appended claims, abstract and accompanying drawings, may be replaced with other equivalence or alternative feature having similar functionality. That is to say, each feature recited is exemplary one of all the possible equivalences or alternatives.

It is also to be understood that the scope of the present invention is not to be interpreted as limited to the specific embodiments disclosed herein, but only is intended to cover all the features and steps of methods or processes recited herein and all the possible combinations thereof.

1. A power rail expansion joint without expansion gap, the expansion joint at least comprising:
two power rail sections,
a limiting guide block,
a sliding contact plate, and
a conductor,
wherein the two power rail sections cooperate with the limiting guide block, with a sliding clearance between the power rail sections and the limiting guide block, such that said power rail sections are configured to just extend or contract in a lengthwise direction thereof;
wherein the limiting guide block is connected to the power rail sections by means of insertion or/and clamping,
wherein the expansion joint comprises at least one conductor which is connected to the limiting guide block or/and the two power rail sections to realize electric connection,
wherein at least one sliding contact plate is mounted on the limiting guide block or base bodies of the power rail sections and has a contact surface of the sliding contact plate arranged in a same working surface with outer contact surfaces of the power rail sections;
wherein the sliding contact plate is configured to partially or completely cover an expansion separation between the two power rail sections;
wherein the sliding contact plate comprises at least one edge which is in an angle of less than 90° with respect to an expansion or contraction direction of the power rail sections,
wherein when the two power rail sections displaced in the lengthwise direction to cause variation of the expansion separation, the sliding contact plate will correspondingly take place displacement in the contact working surface in a direction perpendicular to the expansion or contraction direction of the power rail sections, so as to accommodate the variation of the expansion separation.

2. The expansion joint according to claim 1, wherein the sliding contact plate is mounted on a mount base which is configured as the limiting guide block or the base bodies of the power rail sections, said sliding contact plate cooperating with said mount base through a sliding groove mechanism as a transmission, and in that when said two power rail sections are displaced due to expansion or contraction, the sliding contact plate will correspondingly take place sliding displacement through the sliding groove mechanism in the direction perpendicular to the expansion or contraction direction of the power rail sections.

3. The expansion joint according to claim 2, wherein the sliding groove mechanism is configured as a dovetail groove.

4. The expansion joint according to claim 2, wherein a spring is arranged between the sliding contact plate and the mount base, such that a thrust or tension force of the spring causes the edge of the sliding contact plate to contact with, and thus slide on, an edge of the power rail or an edge of other sliding contact plate.

5. The expansion joint according to claim 3, wherein, when the two power rail sections take place contraction or expansion in the lengthwise direction, the power rail sections are connected to the sliding contact plate through said transmission such that the sliding contact plate is moved along the sliding groove, and in that the sliding contact plate is connected to said transmission, and transmission ratio of said transmission corresponds to the edge slope of the sliding contact plate, such that the edge of the sliding contact plate is moved relatively to the adjacent edge of the power rail sections with fit clearance therebetween remaining unchanged.

6. The expansion joint according to claim 5, wherein said transmission comprises a rack and a gear which are connected to the power rail sections, and a rack which is connected to the sliding contact plate.

7. The expansion joint according to claim 2, wherein said transmission further comprises a guide pulley/track arranged on the power rail sections and a guide block/groove arranged on the sliding contact plate, or in that the guide block/groove is arranged on the power rail sections and the guide pulley/track is arranged on the sliding contact plate.

8. The expansion joint according to claim 4, wherein the at least one sliding contact plate comprises two sliding contact plates configured geometrically similar to each other.

9. The expansion joint according to claim 1, wherein the limiting guide block is configured as a conductive member, the sliding contact plate and the transmission are mounted on said limiting guide block, and both ends of the limiting guide block are electrically connected to said two power rail sections though the conductor.

10. The expansion joint according to claim 9, wherein the limiting guide block is fixed on a groundwork by a separate insulation support.

11. The expansion joint according to claim 2, wherein the limiting guide block is configured as a conductive member, the sliding contact plate and the transmission are mounted on said limiting guide block, and both ends of the limiting guide block are electrically connected to said two power rail sections though the conductor.

12. The expansion joint according to claim 11, wherein the limiting guide block is fixed on a groundwork by a separate insulation support.

13. The expansion joint according to claim 3, wherein the limiting guide block is configured as a conductive member, the sliding contact plate and the transmission are mounted on said limiting guide block, and both ends of the limiting guide block are electrically connected to said two power rail sections though the conductor.

14. The expansion joint according to claim 13, wherein the limiting guide block is fixed on a groundwork by a separate insulation support.

15. The expansion joint according to claim 5, wherein the at least one sliding contact plate comprises two sliding contact plates configured geometrically similar to each other.

16. The expansion joint according to claim 6, wherein the at least one sliding contact plate comprises two sliding contact plates configured geometrically similar to each other.
